(19) United States
(12) Patent Application Publication
(10) Pub. No.: US 2002/0127497 A1
(43) Pub. Date: Sep. 12, 2002

(54) Large diffraction grating for gas discharge laser

(76) Inventors: Daniel J. W. Brown, San Diego, CA (US); Alexander I. Ershov, San Diego, CA (US); Scott T. Smith, San Diego, CA (US); Robert G. Ozarski, Poway, CA (US)

Correspondence Address: Cymer, Inc., Legal Department- MS/1-2A, 16750 Via Del Campo Court, San Diego, CA, 92127-1712, US

(21) Appl. No.: 09/967,695

(22) Filed: Sep. 26, 2001

Related U.S. Application Data
(63) Continuation-in-part of application No. 09/151,128, filed on Sep. 10, 1998.
Application No. 09/151,128 is a continuation-in-part of application No. 09/470,724, filed on Dec. 22, 1999, now Pat. No. 6,192,064.
Application No. 09/470,724 is a continuation-in-part of application No. 09/703,317, filed on Oct. 31, 2000.
Application No. 09/470,724 is a continuation-in-part of application No. 09/716,041, filed on Nov. 17, 2000.
Application No. 09/470,724 is a continuation-in-part of application No. 09/943,343, filed on Aug. 29, 2001.

(51) Int. Cl. G02B 5/18

(52) U.S. Cl. 430/321; 359/566; 359/571; 355/18

(57) ABSTRACT

A grating based line narrowing unit for gas discharge lasers with increased beam expansion to produce smaller bandwidths. The grating has a grating surface larger than 100 cm² and is a replica grating produced from a master grating produced with a lithography process on a single crystal substrate. In preferred embodiments, a beam from the chamber of the laser is expanded with four prism beam expanders. The large grating, much larger than gratings historically produced from diamond lined gratings, permit substantial reductions in bandwidth while maintaining laser efficiency. A narrow band of wavelengths in the expanded beam is reflected from a grating in a Littrow configuration back via the bi-directional beam expanders into the laser chamber for amplification.

This invention relates to lasers and in particular to line narrowed excimer lasers. This invention is a continuation-in-part of Ser. No. 09/151,128, filed Sep. 10, 1998; Ser. No. 09/470,724, filed Dec. 22, 1999; Ser. No. 09/703,317, filed Oct. 31, 2000; Ser. No. 09/716,041, filed Nov. 17, 2000 and Ser. No. 09/943,343, filed Aug. 29, 2001.

### BACKGROUND OF THE INVENTION

### Narrow Band Gas Discharge Lasers

Gas discharge ultraviolet lasers used as light sources for integrated circuit lithography typically are line narrowed. A preferred line narrowing prior art technique is to use a diffraction grating based line narrowing unit along with an output coupler to form the laser resonant cavity. The gain medium within this cavity is produced by electrical discharges into a circulating laser gas such as krypton, fluorine and neon (for a KrF laser); argon, fluorine and neon (for an ArF laser); or fluorine and helium and/or neon (for an F₂ laser).

### Prior Art Line-Narrowing Technique

A sketch of such a prior art system is shown in FIG. 1 which is extracted from Japan Patent No. 2,696,285. The system shown includes output coupler (or front mirror) 4, laser chamber 3, chamber windows 11, and a grating based line narrowing unit 7. The line narrowing unit 7 is typically provided on a lithography laser system as an easily replaceable unit and is sometimes called a “line narrowing package” or “LNP” for short. This unit includes two beam expanding prisms 27 and 29 and a grating 16 disposed in a Litrow configuration so that diffracted beam propogates right back towards the incoming beam. The output of these excimer lasers are typically rectangular with the long dimension of for example 20 mm in the vertical direction and a short dimension of for example 3 mm in the horizontal direction. Therefore, in prior art designs, the beam is typically expanded in the horizontal direction so that the FIG. 1 drawing would represent a top view.

### The Grating Formula

Another prior art excimer laser system utilizing a diffraction grating for spectrum line selection is shown in FIG. 2. The cavity of the laser is created by an output coupler 4 and a grating 16, which works as a reflector and a spectral selective element. Output coupler 4 reflects a portion of the light back to the laser and transmits the other portion 6 which is the output of the laser. Prisms 8, 10 and 12 form a beam expander, which expands the beam in the horizontal direction before it illuminates the grating. A mirror 14 is used to steer the beam as it propagates towards the grating, thus controlling the horizontal angle of incidence. The laser central wavelength is normally changed (tuned) by turning very slightly that mirror 14. A gain generation is created in chamber 3.

Diffraction grating 16 provides the wavelength selection by reflecting light with different wavelengths at different angles. Because of that only those light rays which are reflected back into the laser will be amplified by the laser gain media, while all other light with different wavelengths will be lost. The diffraction grating in this prior art laser works in a Littrow configuration, when it reflects light back into the laser. For this configuration, the incident angle α and the wavelength λ are related through the formula:

2dn sin α=mλ (1)

where α is the incidence angle on the grating, m is the diffraction order, n is refractive index of the gas in the LNP, and d is the period of the grating.

Because microlithography exposure lenses are very sensitive to chromatic abberations of the light source, it is required that the laser produce light with very narrow spectrum line width. For example, state of the art excimer lasers are now producing spectral linewidths on the order of 0.5 pm as measured at full width at half maximum values and with 95% of the light energy concentrated in the range of about 1.5 pm. New generations of microlithography exposure tools will require even tighter spectral requirements. In addition, it is very important that the laser central wavelength be maintained to very high accuracy as well. In practice, it is required that the central wavelength is maintained to better than 0.05-0.1 pm stability.

### Making Gratings

One traditional method of manufacturing diffraction gratings, and particularly echelle gratings, is to scribe or rule a series of grooves with a ruling engine on a good optical surface, such as a thin layer of aluminum or gold deposited on a suitable substrate. However, there are a number of difficulties associated with ruling gratings. Echelles are considered to be among the most difficult gratings to rule because high diffraction angles require exceptional ruling accuracy, yet this must be accomplished under high tool loads that usually accompany coarse groove spacing. The grooves must consistently have a uniform and correct shape to ensure high efficiency. Use at high diffraction orders requires blaze faces to be flat to nanometer tolerances if peak diffracted energy is to be concentrated in one blaze order. The grooves must also be ruled in a parallel and evenly spaced fashion because the density of grooves (e.g. grooves/mm) determines the dispersion and the accuracy in the position of the grooves determines the quality of the spectral image. Additionally, echelles typically have grooves that are deeper than other diffraction gratings (e.g. because of larger blazing angles) which in turn requires thicker metallic coatings consequently effecting the uniformity of the echelles flatness. Ruling engines used to fabricate echelles in this manner are complex mechanical devices that are slow and difficult to use, leading to gratings that are very expensive with long fabrication turnaround times. Large gratings are particularly difficult to make using the ruling techniques. Prior art gratings used for integrated circuit lithography have a lined surface about 24 cm×3.5 cm. Production of high quality gratings larger than this using ruling techniques would be difficult.

Another technique produces so-called holographic gratings. An interference pattern created by two monochromatic, coherent laser beams is used to expose a photoresist film on a substrate. After exposure, the photoresist is developed and the substrate is etched. Although holographic gratings are relatively easy to manufacture, etching the desired blazing angle in such a grating is not, and fabricating high quality holographic gratings whose dimensions exceed 100 mm is very difficult.

FIG. 8 shows a cross section of an echelle grating in the Littrow configuration. Grating 100 includes parallel grooves 110, each with two facets and having a groove spacing d. Facet 120 is located at a blaze angle θ with respect to the plane of the grating. When the angle of incidence α is equal to the diffraction angle β and the blaze angle θ, incident light 130 is diffracted in a given diffracted order 140 (i.e., the m-th order) which propagates backward toward the source.

A need exists for a better technique for making gratings especially large gratings needed to permit reduction in bandwidth for gas discharge lasers.

### SUMMARY OF THE INVENTION

The present invention provides for a grating based line narrowing unit for gas discharge lasers with increased beam expansion to produce smaller bandwidths. The grating has a grating surface larger than 100 cm² and is a replica grating produced from a master grating produced with a lithography process on a single crystal substrate. In preferred embodiments, a beam from the chamber of the laser is expanded with four prism beam expanders. The large grating, much larger than gratings historically produced from diamond lined gratings, permit substantial reductions in bandwidth while maintaining laser efficiency. A narrow band of wavelengths in the expanded beam is reflected from a grating in a Littrow configuration back via the bi-directional beam expanders into the laser chamber for amplification.

### BRIEF DESCRIPTION OF THE DRAWINGS

FIG. 1 shows a first prior art line narrowed laser system.

FIG. 2 shows a second prior art line narrowed laser system.

FIG. 3 shows the effect on wavelengths of vertical beam deviation.

FIGS. 4A, 4B and 4C show elements of a preferred embodiment of the present invention.

FIG. 5 shows beam expansion coefficient possible with one prism.

FIGS. 6 and 7 show techniques for controlling a tuning mirror.

FIG. 8 shows a feature of a grating surface.

FIG. 9 show features of a crystal.

FIGS. 10A-E, 11A-E and 12A-C illustrate a technique for making gratings.

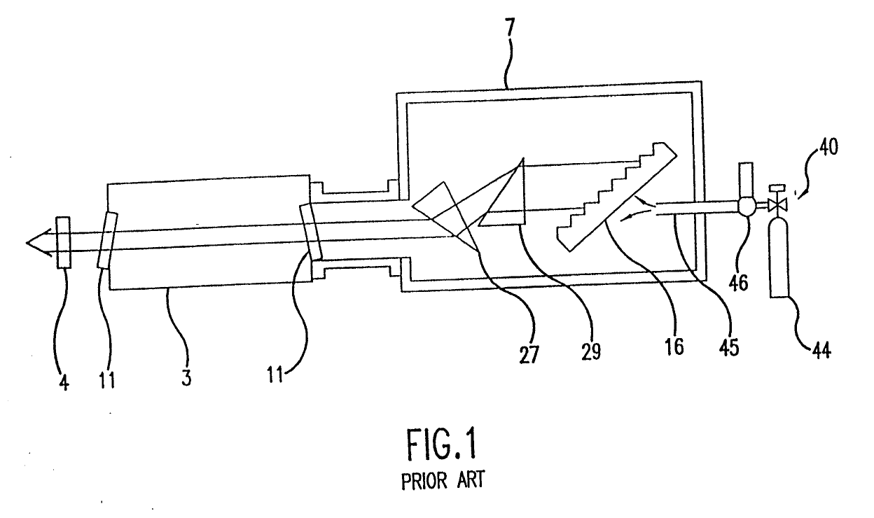

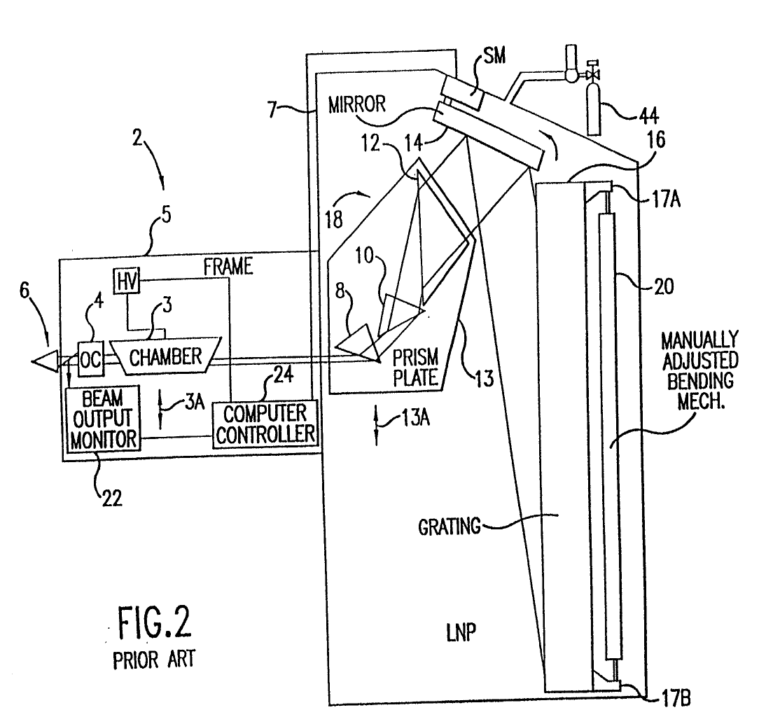

### DETAILED DESCRIPTION OF PREFERRED EMBODIMENTS

Preferred embodiments of the present invention can be described by reference to the drawings.

### Two Direction Beam Expansion

In reality, formula (1) presented in the Background Section only works when all the beams incident on the grating have the same direction in the vertical axes, and this direction is normal to diffraction grating grooves. Diffraction grating grooves are placed vertically so formula (1) works for beams which lay in the horizontal plane.

Real excimer laser beams, however, have some divergence in both horizontal and vertical directions. In this case, formula (1) is modified and becomes

2dn sin α·cos β=mλ (2)

In this formula, β is the beam angle in the vertical direction, the rest of the variables are the same as in (1). In the case of β=0; i.e., when the beam has no divergence in the vertical direction, cos β=1 and formula (2) becomes (1).

It is important to note, that the grating does not have any dispersion properties in the vertical direction, that is, its reflection angle in the vertical direction does not depend on the light wavelength, but is rather equal to the incident angle. That means, in the vertical direction the reflecting facets of the grating face are behaving like ordinary mirrors.

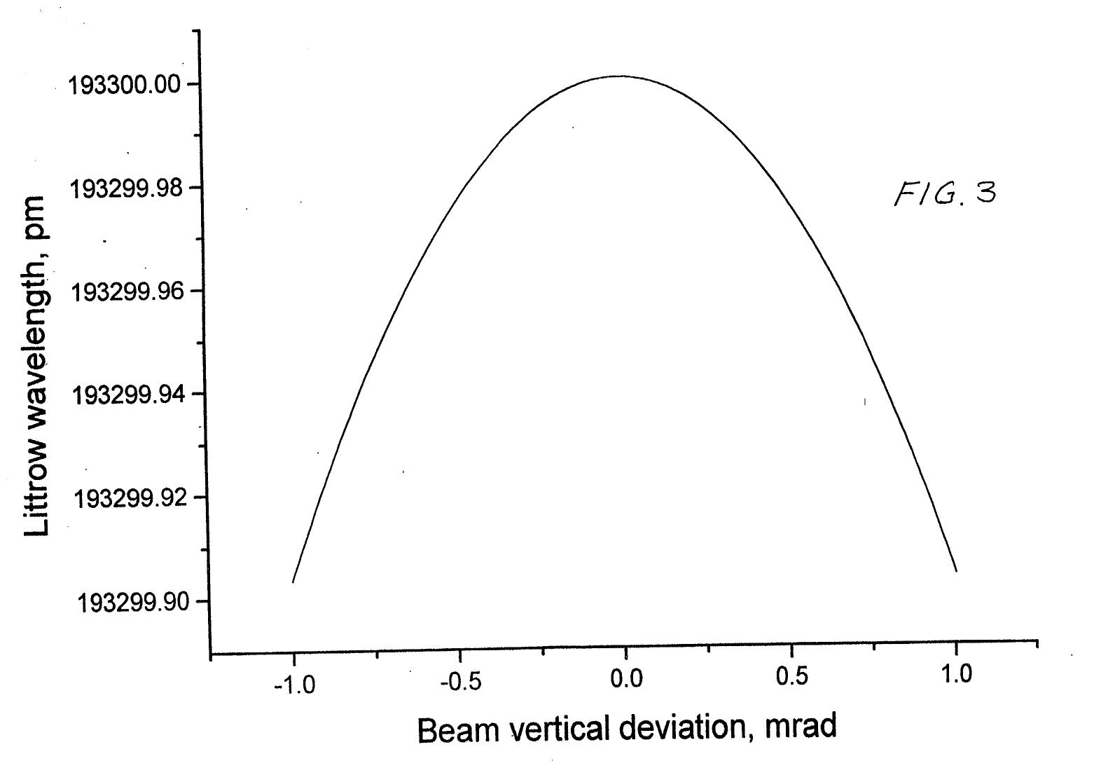

Beam divergence in the vertical direction has significant effect on line narrowing. According to formula (2), different vertical angles β would correspond to different Littrow wavelengths λ. FIG. 3 shows dependence of Littrow wavelength λ on the beam vertical deviation, β. Typical prior art excimer laser might have a beam divergence of up to ±1.0 mrad (i.e., a total beam divergence of about 2 mrad) in the vertical direction. FIG. 3 shows that a portion of a beam propogating with a 1 mrad vertical tilt (in either up or down direction) will have the Littrow wavelength shifted by 0.1 pm to the short wavelength direction for that portion of the beam. This wavelength shift leads to broadening of the whole beam spectrum. Prior art excimer lasers, having Δλ_{FWHM} bandwidth of about 0.6 pm does not substantially suffer from this effect. However, as the bandwidth is reduced, this 0.1 pm shift becomes more important. New excimer laser specifications for microlithography will require bandwidth of about 0.4 pm or less. In this case, it becomes important to reduce this broadening effect.

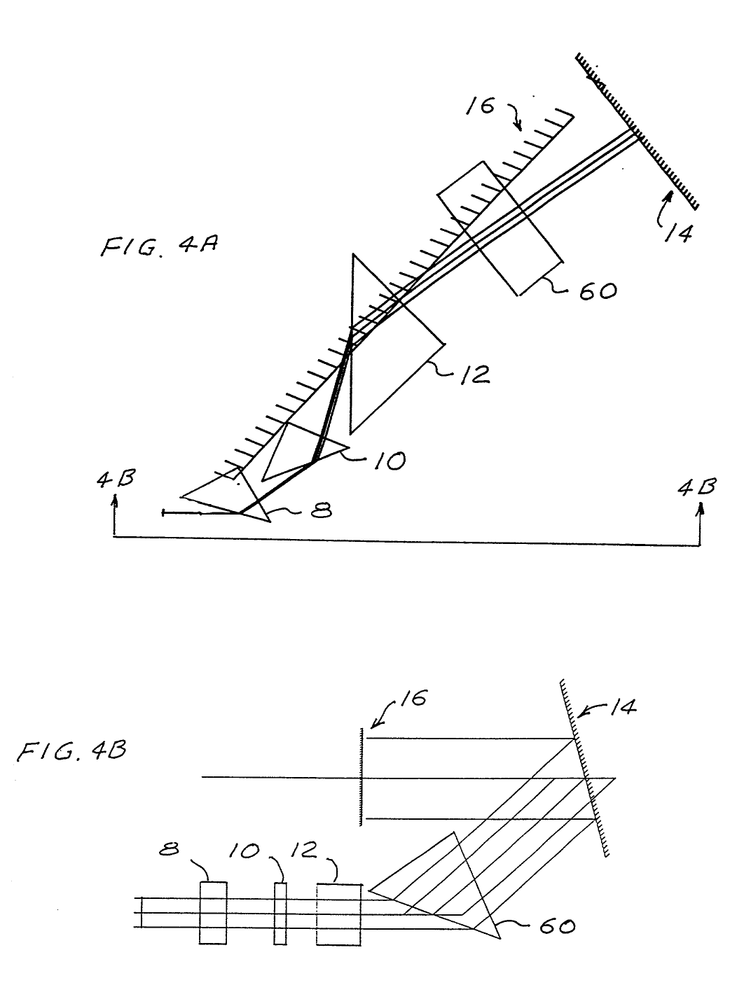

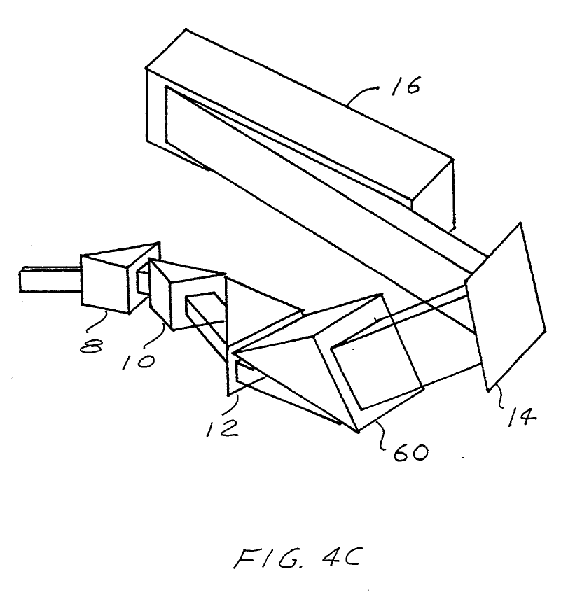

A preferred line narrowing module of the present invention is shown in FIGS. 4A, B and C. It has three beam expanding prisms that expand the beam in the horizontal direction and one additional prism, which expands the beam in the vertical direction.

FIG. 4A is a top view. FIG. 4B is a side view from the side indicated in FIG. 4A. (In FIG. 4B the prisms are depicted as rectangles representing the portion of the prisms through which the center of the beam passes.) FIG. 4C is a prospective view. Note that the grating 16 and mirror 14 are at a higher elevation than prisms 8, 10, and 12. Note that the expanded beam heads off in a direction out of the plane of the horizontal beam expansion. The beam then is redirected back into a second horizontal plane parallel to the plane of the horizontal expansion by mirror 14 onto the face of the grating 16 which is positioned in the Littrow configuration in the second horizontal plane. (Grating 16 is shown as a line in FIG. 4B representing the intersection of the horizontal center of the beam with the grating surface.)

In the preferred embodiment, each of the three horizontally expanding prisms expands the beam by about 2.92 times. Therefore, total beam expansion in the horizontal direction is 2.92³=25 times. The beam expansion in the vertical direction is 1.5 times. (The degree of expansion is exaggerated in FIGS. 4B and C.) This vertical beam expansion does not directly affect the beam divergence in the laser cavity or the vertical beam divergence of the output laser beam, but it does reduce the vertical divergence of the beam as it illuminates the grating surface. After the beam is reflected from the grating, prism 60 contracts the beam in its vertical direction as it passes back through the prism thus increasing its divergence back to normal. This reduced divergence of the beam as it illuminates the grating results in a reduction in the wavelength shift effect thus producing better line-narrowing. A vertical tilt of 1 mrad of the beam before it goes through this prism is reduced to

$$\frac{1 mrad}{1.5} = 0.67 mrad .$$

According to FIG. 3, this will correspond to wavelength shift reduction from 0.1 pm to a mere 0.044 pm making this effect insignificant for line narrowing of the next generation of lasers.

### Need for Large Grating

The two direction beam expander requires a larger grating than prior art gratings used for integrated circuit light sources. In the case described above, the grating would need to be about 50 percent larger in the vertical direction.

### Forty-Five X Horizontal Beam Expander

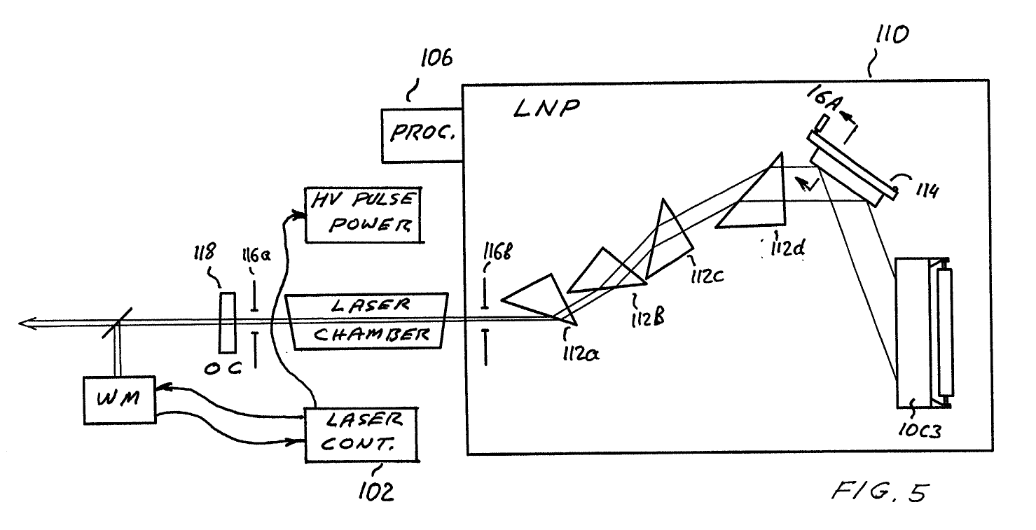

FIG. 5 shows another technique for greatly reducing bandwidths of gas discharge lasers. Line narrowing is done by a line narrowing module 110, which contains a four prism beam expander (112a-112d), a tuning mirror 114, and a grating 10C3. In order to achieve a very narrow spectrum, very high beam expansion is used in this line narrowing module. This beam expansion is 45× as compared to 20×-25×typically used in prior art microlithography excimer lasers. In addition, the horizontal size of front (116a) and back (116B) apertures are made also smaller, i.e., 1.6 and 1.1 mm as compared to about 3 mm and 2 mm in the prior art. The height of the beam is limited to 7 mm. All these measures allow to reduce the bandwidth from about 0.5 pm (FWHM) to about 0.2 pm (FWHM). The laser output pulse energy is also reduced, from 5 mJ to about 1 mJ. This, however, does not present a problem, because this light will be amplified in a power amplifier 120 to produce a 10 mJ desired output per pulse. The reflectivity of the output coupler 118 is 30%, which is close to that of prior art lasers.

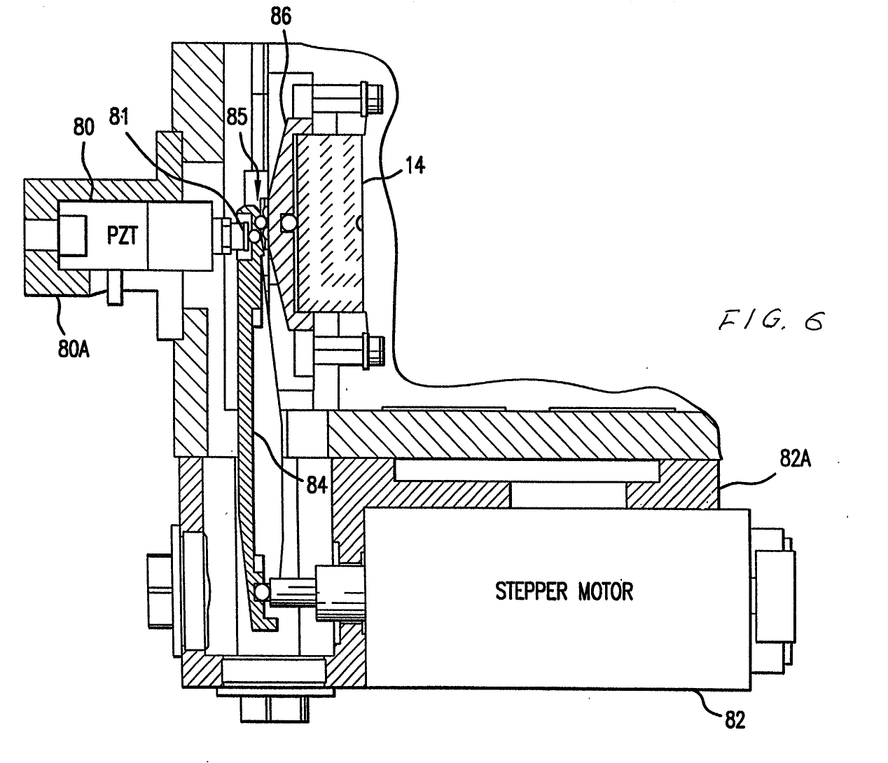

FIG. 6 is a drawing showing detail features of a preferred embodiment of the present invention. Large changes in the position of mirror 14 are produced by stepper motor through a 26.5 to 1 lever arm 84. In this case a diamond pad 81 at the end of piezoelectric drive 80 is provided to contact spherical tooling ball at the fulcrum of lever arm 84. The contact between the top of lever arm 84 and mirror mount 86 is provided with a cylindrical dowel pin on the lever arm and four spherical ball bearings mounted (only two of which are shown) on the mirror mount as shown at 85. Piezoelectric drive 80 is mounted on the LNP frame with piezoelectric mount 80A and the stepper motor is mounted to the frame with stepper motor mount 82A. Mirror 14 is mounted in mirror mount 86 with a three point mount using three aluminum spheres, only one of which are shown in FIG. 6. Three springs 14A apply the compressive force to hold the mirror against the spheres.

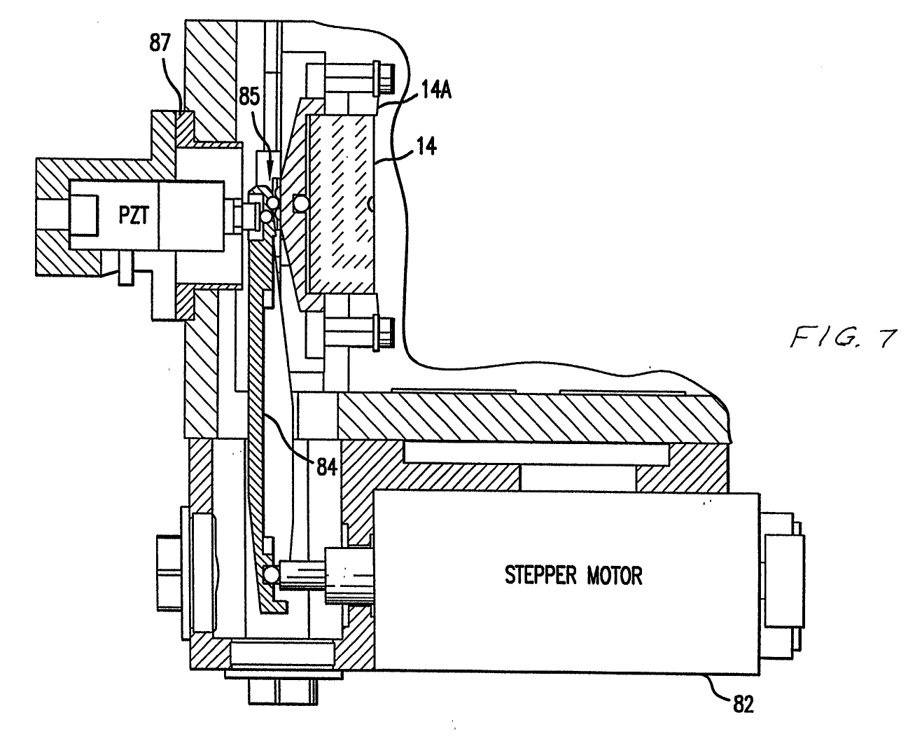

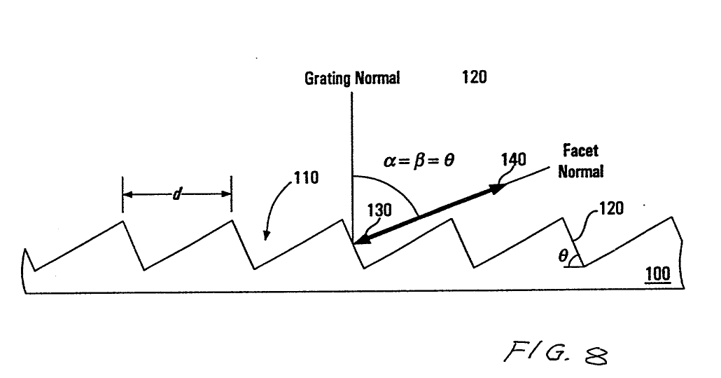

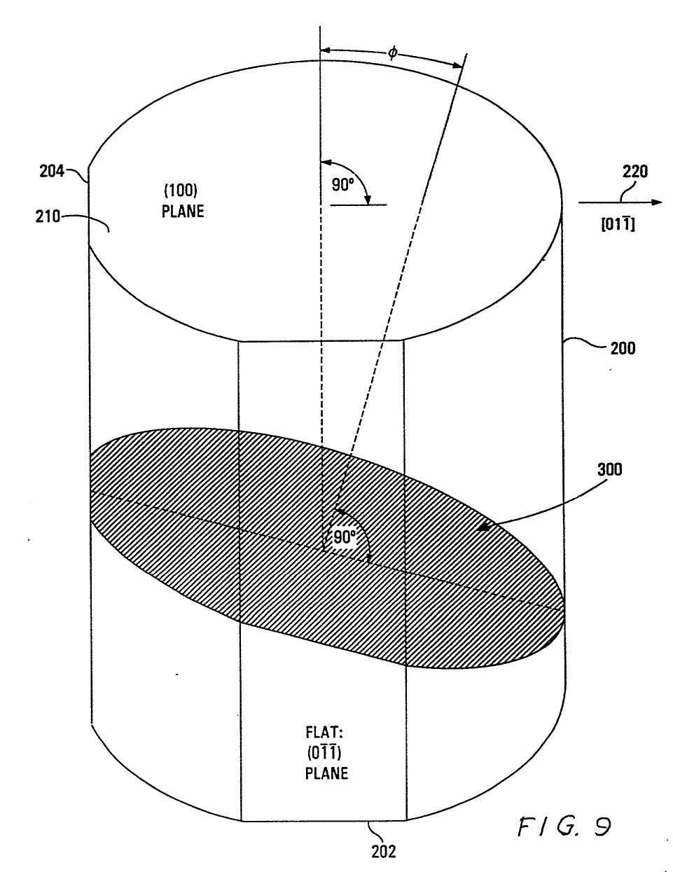

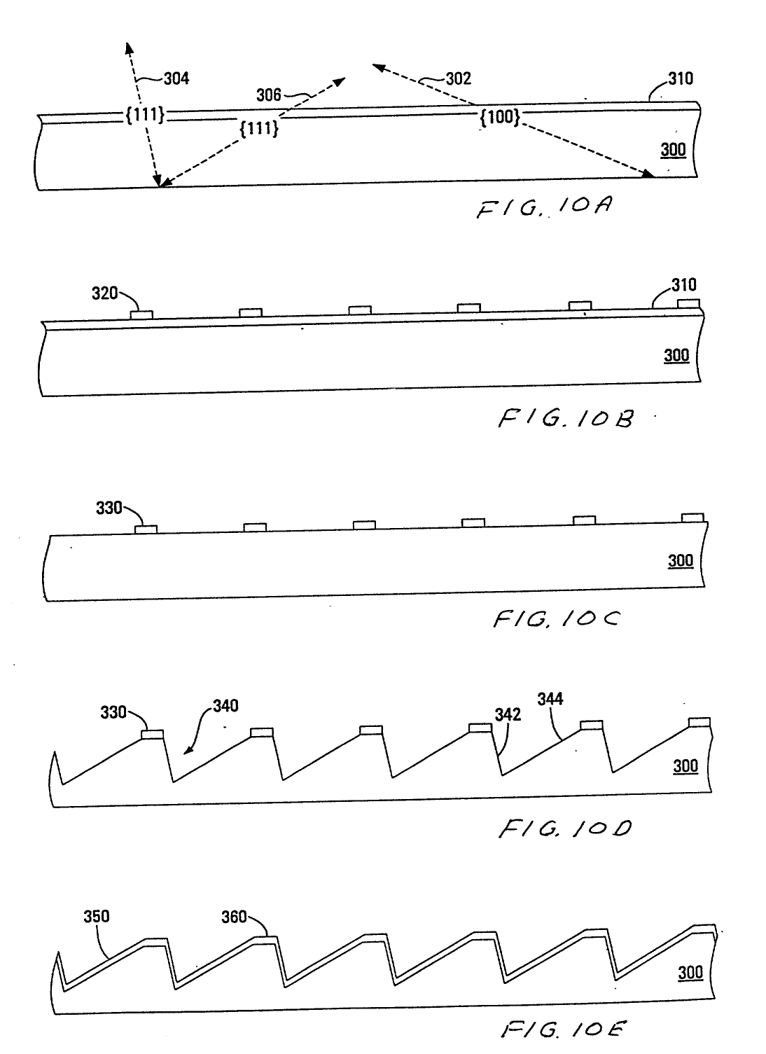

FIG. 7 is a second preferred embodiment slightly different from the one shown in FIG. 6. This embodiment includes a bellows 87 (which functions as a can) to isolate the piezoelectric drive from the environment inside the LNP. This isolation prevents UV damage to the piezoelectric element and avoid possible contamination caused by out-gassing from the piezoelectric materials.

### Large Gratings Made Using Lithographic Techniques

Applicants have developed techniques for making large gratings needed to provide bandwidth reductions for lithography laser light sources. These techniques utilize some of that same lithographic processes that the laser lithographic light sources support. This is a matter of bootstrap technology advancement.

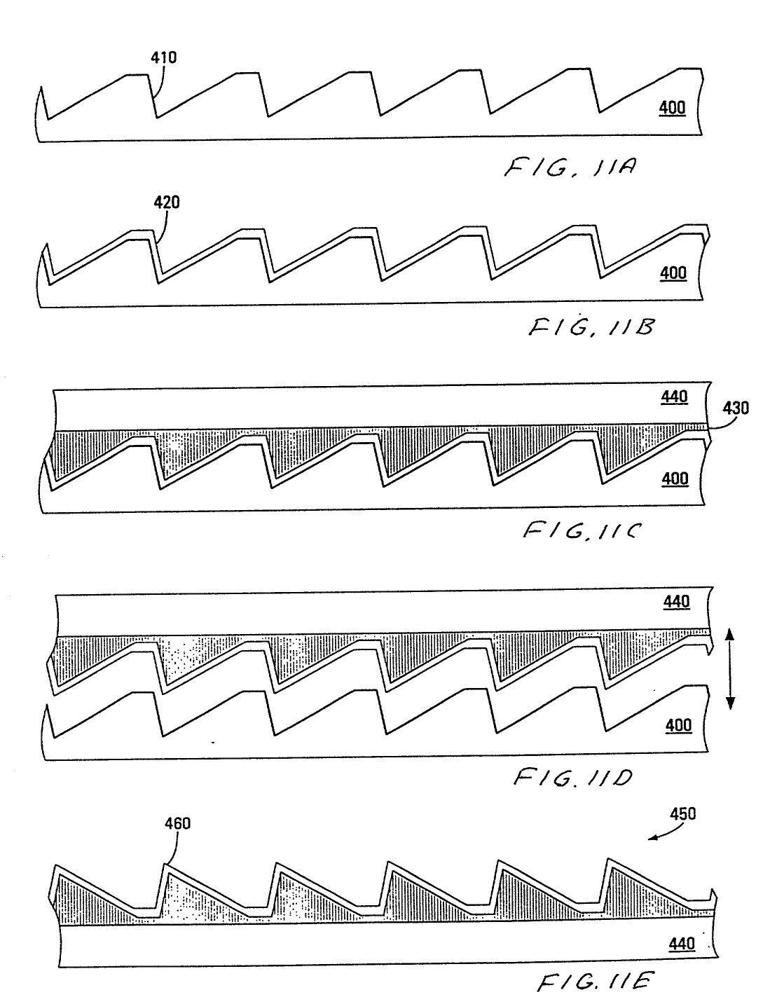

To fabricate a grating with a desired blaze angle using lithographic techniques, it is useful to etch silicon more rapidly along some crystal planes than others. This anisotropic etching allows the etch to significantly slow down or to etch specific shapes or structures in the silicon. In the diamond lattice of silicon, the (111) plane (or its equivalents generally designated as {111} planes) is more densely packed than the (100) plane (see FIG. 9). Consequently, etch rates of (111) oriented surfaces are expected to belower than those of with (100) orientations. One common anisotropic wet etchant for silicon is a mixture of potassium hydroxide (KOH) and isopropyl alcohol. The etch rate of this etchant is about 100 times faster along (100) planes than along (111) planes.

In order to etch a diffraction grating with grooves whose facets are at a desired angle with respect to each other, a single crystal substrate must be carefully chosen keeping in mind both the relative angles of the crystallographic planes of the singlecrystal substrate, and the orientation of those planes with respect to the plane of the diffraction grating, for example the plane of the substrate. FIG. 9 shows a boule of single crystal silicon 200. High purity, single crystal silicon is grown using a variety of techniques including the Czochralski method and the floating zone method. Additionally, single crystal silicon is grown in a variety of orientations depending on the desired application. Silicon boule 200 is grown with the (100) plane perpendicular to the length of the boule (i. e., the direction of growth), an orientation common in semiconductor manufacturing. Consequently, wafers sawn from the boule perpendicular to the growth axis has a surface with the (100) orientation. Silicon boule 200 includes flats 202 and 204 which are formed in the boule, by, for example, grinding, to help indicate the crystallographic axes of the silicon. In order to take advantage of the anisotropic etching of the {111} planes as noted above, a wafer to be etched should be cut from the boule at an angle φ with respect to the normal of the (100) plane, so that subsequent etching yields the desired angular grating groove facetfeatures. For example, in order to fabricate a grating groove facet at an angle of 78.81° with respect to the plane or surface of the substrate wafer (i.e. the grating's blaze angle) and using anisotropic etching, the substrate wafer should be cut from the boule so that the angle between the surface and one of the {111} planes is 78.81°. Thus, substrate 300 is cut from boule 200 at an angle φ=24.07° (because the (111) plane forms an angle of 54.74° with the (100) plane) with respect to the normal of the (100) plane and in the direction shown by arrow 220. Substrate 300 then receives conventional wafer manufacturing processes including polishing both sides to provide thickness uniformity and flatness (e.g. a flatness of less than 5 μm).

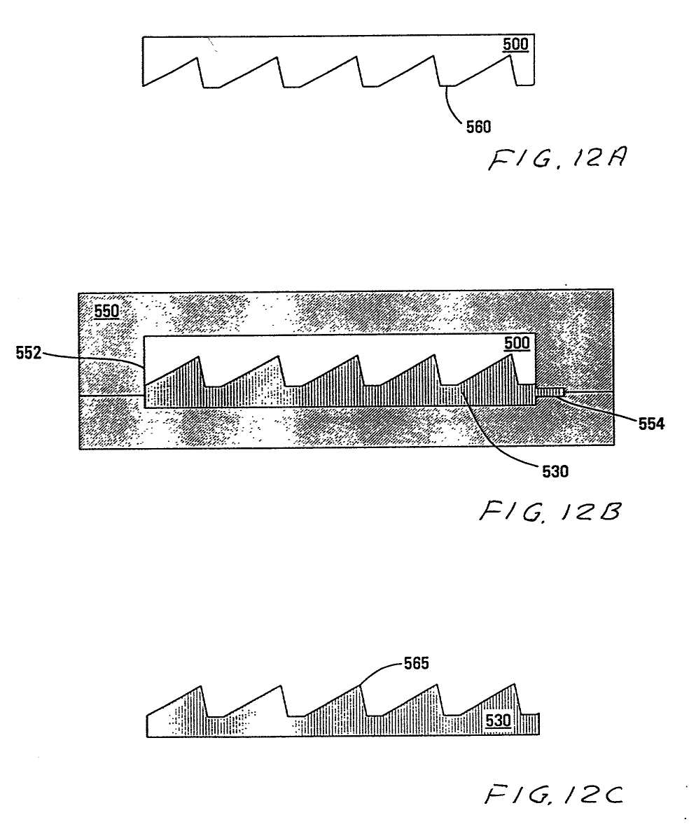

FIG. 10A shows a cross-section of substrate 300 including the location of a {100} plane and two {111} planes as shown by 302, 304, and 306 respectively. Substrate 300 also includes an oxide layer 310. Alignment marks (not shown) are etched into the substrate to determine precisely the crystallographic axes. Note that the alignment marks can be etched following the same general steps as outlined below for the etching of the grating grooves. Those having ordinary skill in the art will readily recognize that there are a variety of photolithographic and micromachining techniques suitable for use in fabricating the disclosed gratings including the alignment marks.

FIG. 10B shows multiple photoresist mask features 320. The photoresist mask features 320 are formed by coating the substrate with a layer of photoresist; selectively exposing the photoresist through a photomask, using, for example, a contact printing technique or direct writing; developing the photoresist; and curing the photoresist (e.g. baking) as necessary. The photomask can be generated, for example, by e-beam and have a plurality of parallel stripes. The width of the stripes defines the width of the etching mask, and the pitch of the stripes (i.e. the distance between the beginning edge of one stripe and the beginning edge of the next stripe) relates to the final groove spacing d. For example, the width of the stripes can be approximately 3 μm and the pitch can be approximately 12 μm.

Next, oxide layer 310 is isotropicly etched, and photoresist mask features 320 are removed leaving a plurality of oxide hard mask features 330, as seen in FIG. 10C. FIG. 10D shows the results of anisotropic etching of the substrate 300 such that a {100} plane is etched more rapidly than other crystallographic planes. Multiple grooves 340 are formed, each with facets 342 and 344. In the example shown, both facets are {111 } planes, and the angle between the facets is defined by an inherent angle between {111 } planes in single crystal silicon. The oxide hard mask features 330 are removed, the substrate is cleaned, and a coating of reflective material 350, for example vacuum deposited aluminum which has high reflectance for DUV light, is deposited on the surface of the etched substrate, as shown in FIG. 10E. Protective coatings such as SiO₂, SiN₄, and MgF₂ can be deposited prior to deposition of the reflective coating. Additionally, a variety of different metallic (e.g. chromium and nickel) and dielectric coatings (either single or multiple layers) can be deposited as indicated by the particular application for the diffraction grating. Protective coatings can even be deposited on top of the reflective coating or coatings. Once completed, the remaining portions of substrate 300 can serve as a substrate for mounting purposes. Alternatively, the grating can be attached to another substrate material. By attaching several gratings to the same substrate, a single, larger grating can be achieved.

Flats 360 on the top edges between adjacent grooves 340 are caused by the mask used to etch the grooves. Flats 360 are generally undesirable because they prevent incident light from reflecting off a blazed facet such as facet 342. Flats 360 can be reduced and even eliminated in some circumstances by over-etching the silicon and/or minimizing the width of the mask features. Alternatively, the flats can be eliminated by making a replica of the grating, as shown in FIGS. 11A-11E.

The fabrication of a replica grating begins with a master grating such as grating 400. Grating 400 is similar to the grating of FIG. 10E, except that reflective coating 350 has not been deposited, and a thin film of a separating compound 410 has been deposited on the grating. Alternatively, separating compound 410 is deposited on top of reflective coating 350, or in some circumstances, no separating compound is used. FIG. 11B shows that a reflective coating 420 is deposited over the thin film of separating compound. Reflective coating 420 will form the reflective surface of the replica grating. Alternatively, no reflective coating can be deposited at this point in the replication process, and instead a reflective coating can be added after the replica grating is separated from the master grating. Next, the coated master grating 400 is cemented to replica substrate 440 using a layer of resin 430, allowing the resin to polymerize, as shown in FIG. 11C. Replica substrate 440 can be made from glass, such as standard optical glass, BK-7, Pyrex™, ZeroDur™, ULE®, or fused silica. Other materials, such as metal or light-weight composites can also be used. Additionally, a variety of different resins including both polyester and epoxy based resins are suitable for resin 430. FIG. 11D illustrates the separation of the master grating from the replica once resin 430 is sufficiently set. Because of the separation layer and the resin, reflective coating 420 remains attached to the replica grating 450. Because the facets meet at the bottom of each groove in the master grating, the top edge 460 between grooves in the replica grating is generally a sharp edge, and the flats 360 shown in FIG. 10E are eliminated.

Another example of a technique for fabricating replica gratings makes use of compact disc (CD) manufacturing technology. With CDs, the mastering process typically begins with a polished, flat glass master. The master is coated with a layer of photoresist which is then exposed to light from a recording laser. If the photoresist is a positive photoresist, portions of the photoresist that are exposed to light are removed in a subsequent developing step. If the photoresist is a negative photoresist, non-exposed portions of the photoresist layer are removed in a subsequent developing step. Thus, a master is created with either pits or projections representing the binary data recorded on the disk. The master is then coated with a thin layer of metal (e.g. silver and/or nickel). The metalized master is then subjected to an electroforming process where additional metal is added to the thin layer of metal by, for example, electroplating, until a required thickness is achieved. This thick metal layer, often referred to as a “father,” is then separated from the master, and represents a negative image of the master. Because the father is a negative of the master, it can be used as a stamper to replicate CDs directly. Alternatively, the electroforming process can be performed using the father to replicate an additional master or “mother.” The mother, in turn, is used to electroform multiple copies (“sons”) of the stamper needed to produce CDs. Note that the electroforming process can be conducted using a variety of techniques and materials. Additional steps can be included, such as depositing a separation layer between either the master, the father, or the mother and a subsequent electroformed metal layer.

Once a suitable stamper is produced, it is installed in a compression mold or injection mold. Molten plastic, such as polymethylacrylate or polycarbonate, is injected into the mold at high pressure against the stamper. The plastic is then cooled rapidly before the disc is removed. Next, a reflective layer such as aluminum is deposited on the data side of the disk. Finally, a protective layer is deposited over the deposited on the data side of the disk. Finally, a protective layer is deposited over the aluminum.

In modifying this process for the fabrication of replica diffraction gratings, the CD glass master is replaced with a master diffraction grating such as grating 500 as shown in FIG. 12A. Grating 500 is similar to the grating of FIG. 10E, except that reflective coating 350 has not been deposited. Grating 500 can be used as the stamper in an injection or compression mold as shown in FIG. 12B. Mold 550 includes a cavity 552 within which grating 500 is placed to serve as the stamper. The remaining space of cavity 552 is filled by way of inlet 554 with plastic, such as polymethylacrylate or polycarbonate, to form replica grating 530. After the plastic cools and hardens, grating 530 is removed from the mold as shown in FIG. 12C. The replica can then be coated with reflective and/or protective materials, and attached to another substrate if desired. Because the facets meet at the bottom of each groove in the master grating, top edge 565 between grooves in the replica grating is generally a sharp edge, and the flats 360 shown in FIG. 10E are eliminated.

As in the case of CD replication, the stamper can be a father, mother, or son that has been electroformed based on the original master diffraction grating. Since one advantage of any replica created from the master diffraction grating described above is a sharp top edge between grooves, a preferred stamper would be an electroformed mother, that is a stamper with the same surface profile as the master grating and formed from a father which is, in turn, formed from the master diffraction grating. Using a mother stamper ensures that the flats 360 are located at the bottom of grating. Using a mother stamper ensures that the flats 360 are located at the bottom of grooves, and the edges between the grooves are sharp.

Although the master diffraction grating of the present invention is shown fabricated from silicon, a number of different single crystal materials can be used, including, for example, gallium arsenide (GaAs). Additionally, a variety of different wet and dry etchants can be used to achieve the desired preferential etching leading to specific grating features given the material being etched, the orientation of the material's crystallographic planes, and the orientation of the surface of the grating substrate.

Techniques for substantially real time control of several wavelength parameters are described in a U.S. patent application filed Sep. 3, 1999, Ser. No. 09/390,579 and in a U.S. patent application filed Oct. 31, 2000, Ser. No. 09/703,317 which are incorporated by reference herein. These techniques include fast feedback control of the position of the beam expanding prisms, grating curvature and tuning mirror position. Control of the position of the laser chamber is also provided.

The description of the invention set forth herein is illustrative and is not intended to limit the scope of the invention as set forth in the following claims. Variations and modifications of the embodiments disclosed herein may be made based on the description set forth herein, without departing from the scope and spirit of the invention as set forth in the following claims.

We claim:

1. A grating comprising:
A) a single crystal substrate having grating surface larger than 100 cm²; and
B) a plurality of substantially parallel grooves formed in the grating surface of the substrate using a lithography process, each groove including:
1) a first facet substantially coplanar with a first crystallographic plane of the substrate; and
2) a second facet aparallel to the first facet and substantially coplanar with a second crystallographic plane of the substrate,
the diffraction grating having a blaze angle defined by the surface of the substrate and the first facet.

2. The diffraction grating of claim 1 further comprising a thin film reflective coating.

3. The diffraction grating of claim 2 wherein the thin film reflective coating is aluminum.

4. The diffraction grating of claim 1 wherein the substrate is silicon and the first crystallographic plane is a 111 plane.

5. The diffraction grating of claim 4 wherein the blaze angle is approximately 78°.

6. A grating of claim 1 wherein said grating surface is larger than 100 cm².

7. A grating of claim 1 wherein said grating surface is larger than 150 cm.

8. A replica diffraction grating comprising:
A) a substrate; and
B) a resin layer disposed on a surface of the substrate, the resin layer including a first plurality of substantially parallel grooves formed by contact with a master diffraction grating having a grating surface greater than 100 cm² formed using a lithography process, the master diffraction grating including:
C) a single crystal substrate having a surface; and
D) a second plurality of substantially parallel grooves formed in the single crystal substrate, each groove including:
1) a first facet substantially coplanar with a first crystallographic plane of the substrate; and
2) a second facet aparallel to the first facet and substantially coplanar with a second crystallographic plane of the substrate,
the master diffraction grating having a blaze angle defined by the angle between the surface of the single crystal substrate and the first facet.

9. The replica diffraction grating of claim 8 further comprising a thin film reflective coating overlying the resin layer.

10. The replica diffraction grating of claim 8 wherein the resin is selected from a polyester resin and an epoxy resin.

11. The replica diffraction grating of claim 8 wherein the single crystal substrate of the master diffraction grating is silicon and the first crystallographic plane is a 111 plane.

12. The replica diffraction grating of claim 8 wherein the blaze angle is approximately 78°.

13. A method of fabricating a diffraction grating comprising:
A) providing a single crystal substrate including a top surface having an area greater than 100 cm², the top surface oriented with respect to a first crystallographic plane of the substrate so as to define a blaze angle therebetween;
B) depositing a photoresist layer on the substrate;
C) exposing and developing the photoresist layer to form a plurality of substantially parallel mask features;
D) preferentially etching the substrate with a first etchant along a third crystallographic plane to form a plurality of grooves, each groove formed between two adjacent mask features and having a first facet and a second facet, the first facet substantially coplanar with the first crystallographic plane and the second facet being substantially coplanar with a second crystallographic plane; and
E) removing the mask features.

14. The method of claim 13 further comprising:
A) forming an alignment mark in the substrate, the alignment mark determining at least one crystallographic axis.

15. The method of claim 14 wherein the single crystal substrate includes an oxide layer formed along the top surface, and wherein the exposing and developing further comprises:
A) aligning a photomask having a plurality of substantially parallel lines to the alignment mark;
B) exposing the photoresist through the photomask;
C) developing the photoresist layer to form a plurality of substantially parallel photoresist lines; and
D) etching away exposed portions of the oxide layer with a second etchant to form the plurality of mask features from the oxide layer.

16. The method of claim 15 wherein the first etchant and the second etchants are wet etchants.

17. The method of claim 16 wherein the single crystal substrate is silicon, the first etchant includes potassium hydroxide, and the second etchant includes hydrofluoric acid.

18. The method of claim 13 further comprising depositing a reflective coating on the facets of the plurality of grooves.

19. The method of claim 18 wherein the reflective coating is aluminum.

20. The method of claim 13 wherein the mask features are removed during the etching of the substrate with the first etchant.

21. A laser lithography light source for producing a narrow band ultraviolet output laser beam comprising:
A) a discharge laser chamber containing a pair of elongated electrodes and a circulating laser gas said chamber being configured to produce a laser gain medium,
B) a line narrowing module comprising:
1) a prism beam expander comprised of at least four prisms for expanding laser beams produced in said gain medium by a ratio greater than 40 in a first direction to produce expanded beams;
C) a grating comprising:
1) a substrate; and
2) a resin layer disposed on a surface of the substrate, the resin layer including a first plurality of substantially parallel grooves formed by contact with a master diffraction grating having a grating surface greater than 84 cm² formed using a lithography process, the master diffraction grating including:
3) a single crystal substrate having a surface; and
4) a second plurality of substantially parallel grooves formed in the single crystal substrate, each groove including:
i) a first facet substantially coplanar with a first crystallographic plane of the substrate; and
ii) a second facet aparallel to the first facet and substantially coplanar with a second crystallographic plane of the substrate,
5) the master diffraction grating having a blaze angle defined by the angle between the surface of the single crystal substrate and the first facet,
D) a tuning mirror for directing said expanded beam onto said grating surface of said grating and for controlling directions of said expanded beam.

22. A light source as in claim 21 wherein said beam expander is configured to expand in two directions said laser beams produced in said gain medium.

23. A light source as in claim 21 and further comprising a power amplifier for amplifying said narrow band output beam to produce an amplified narrow band output beam.
